(19) United States
(12) Patent Application Publication
(10) Pub. No.: US 2008/0282022 A1
(43) Pub. Date: Nov. 13, 2008

(54) Partially storing software functions that are not expected to change over time in ROM instead of RAM

(75) Inventors: Yury Gonikberg, San Jose, CA (US); Guillermo Loyola, Palo Alto, CA (US); Curt McDowell, Mountain View, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/801,208

(22) Filed: May 9, 2007

(51) Int. Cl. G06F 12/00

(52) U.S. Cl. 711/102

(57) ABSTRACT

A technique to identify portions of software that does not change over time, in order to store that portion in ROM, instead of RAM, to reduce RAM size. The smaller RAM conserves space on a chip and consumes less power. The technique allows wireless devices, such as cell phones, to use less RAM.

### BACKGROUND OF THE INVENTION

1. Technical Field of the Invention

The embodiments of the invention relate to communication devices and more particularly to a memory loading scheme in allocating software to ROM and RAM in a wireless device.

2. Description of Related Art

Communication systems are known to support wireless and wire lined communications between wireless and/or wire lined communication devices. Such communication systems range from national and/or international cellular telephone systems to the Internet to point-to-point in-home wireless networks. Communication systems typically operate in accordance with one or more communication standards. For instance, wired communication systems may operate according to one or more versions of the Ethernet standard, the System Packet Interface (SPI) standard, or various other standards. Wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). Typically, the transceiver includes a data modulation stage and an RF stage. The data modulation stage (baseband process) converts between data and baseband signals in accordance with the particular wireless communication standard. The RF stage (transmitter section and receiver section) converts between baseband signals and RF signals. The RF stage may be a direct conversion transceiver that converts directly between baseband and RF or may include one or more intermediate frequency stages.

Wireless communication devices, particularly small handheld devices typically are limited in size as to what components reside in them. For example, cell phones and portable down-loadable music players are handheld devices having compact electronics packaged in them. In most instances, these devices utilize some form of read-write memory, such as random-access memory (RAM), or even flash memory in some instances, to store various applications programs and down-loaded data. Unlike desktop devices, such as personal computers, the amount of RAM that may be present in a handheld device is limited by its size.

Another type of memory that may be present in a wireless device is a read-only memory (ROM). A ROM is generally present to hold boot programs or other programs that are associated with initialization or reset. These booting types of programs are generally stored in ROM, since boot programs do not change for the device, unlike applications programs that may be updated. For example, a particular driver program is typically stored in RAM, since driver updates are quite common.

An advantage of using RAM-type memory is the ability to load updates to existing programs or even change the program as new programs or devices become available. Although it may be beneficial to have as much RAM as possible for the device, the small size of the wireless device may limit the amount of RAM that may be resident in the device. RAM not only takes much more chip real estate to store a bit of memory, as compared to a ROM, but a RAM consumes much more power than a ROM. Power consumption is a significant concern for portable devices that run on a battery.

Accordingly, it would be advantageous to implement a scheme in which more programs are stored in ROM instead of RAM, where such allocation may be made.

### SUMMARY OF THE INVENTION

The present invention is directed to apparatus and methods of operation that are further described in the following Brief Description of the Drawings, the Detailed Description of the Embodiments of the Invention, and the Claims. Other features and advantages of the present invention will become apparent from the following detailed description of the embodiments of the invention made with reference to the accompanying drawings.

### BRIEF DESCRIPTION OF THE SEVERAL VIEWS OF THE DRAWINGS

FIG. 1 is a block schematic diagram illustrating a wireless communication system in accordance with one embodiment of the present invention.

FIG. 2 is a schematic block diagram illustrating a wireless communication device in accordance with one embodiment of the present invention.

FIG. 3 is a system diagram illustrating a loading of programs in ROM and RAM of a wireless device according to one embodiment of the present invention.

FIG. 4A is a diagram showing a loading of a boot operating system in ROM and other programs in RAM.

FIG. 4B is a diagram showing a loading of a boot operating system, along with some programs that do not change, in ROM and remaining programs in RAM to use less RAM.

FIG. 5 is a flow diagram illustrating a separation of programs for loading into ROM or RAM, based on identifying those programs that do not change over time.

### DETAILED DESCRIPTION OF THE EMBODIMENTS OF THE INVENTION

The embodiments of the present invention may be practiced in a variety of settings that implement a wireless device that uses a read-only memory (ROM) and a read-write memory, such as a random-access memory (RAM).

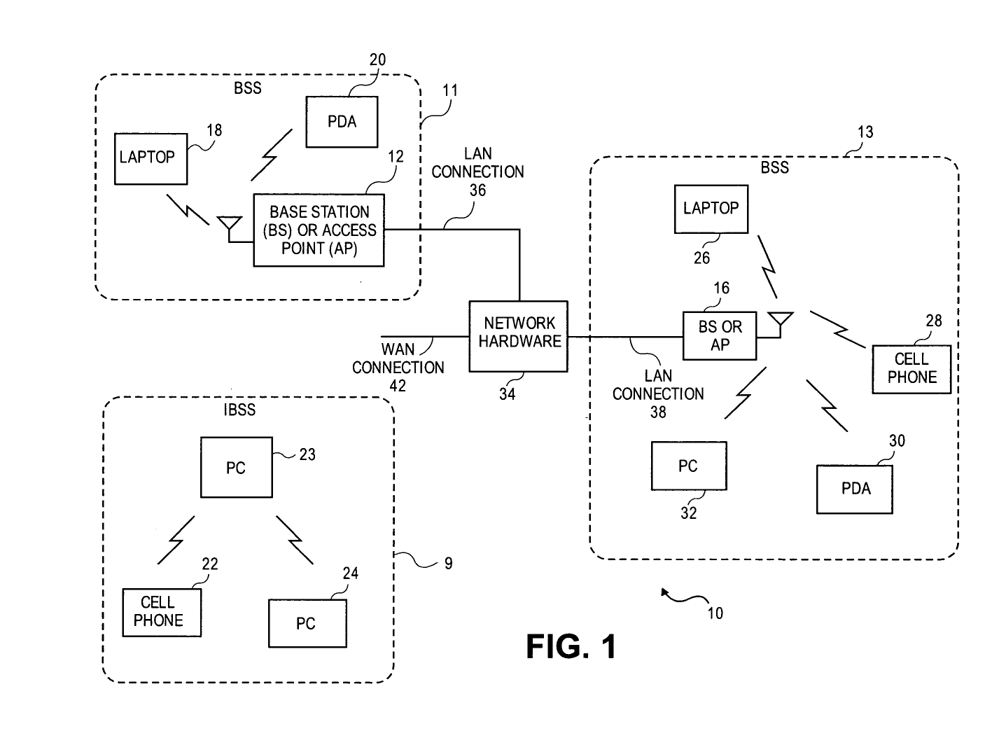

FIG. 1 is a block schematic diagram illustrating a communication system 10 that includes a plurality of base stations and/or access points 12, 16, a plurality of wireless communication devices 18-32 and a network hardware component 34. Network hardware 34, which may be a router, switch, bridge, modem, system controller, et cetera, provides a wide area network connection 42 for the communication system 10. Wireless communication devices 18-32 may be laptop host computers 18 and 26, personal digital assistant hosts 20 and 30, personal computer hosts 24 and 32 and/or cellular telephone hosts 22 and 28, as well as other devices.

Wireless communication devices 22, 23, and 24 are located within an independent basic service set (IBSS) area and communicate directly (i.e., point to point). In this configuration, these devices 22, 23, and 24 typically only communicate with each other. To communicate with other wireless communication devices within system 10 or to communicate outside of system 10, devices 22, 23, and/or 24 affiliate with one of the base stations (BS) or access points (AP).

Base stations or access points 12, 16 are located within basic service set (BSS) areas 11 and 13, respectively, and are coupled to network hardware 34 via one or more of local area network connections 36, 38. Such a connection provides base station or access point 12, 16 with connectivity to other devices within system 10 and may also provide connectivity to other networks via a WAN connection 42. To communicate with the wireless communication devices within its BSS 11 or 13, each of the base stations or access points 12, 16 has an associated antenna or antenna array. For instance, base station or access point 12 wirelessly communicates with wireless communication devices 18 and 20 while base station or access point 16 wirelessly communicates with wireless communication devices 26, 28, 30, 32. Typically, the wireless communication devices register with a particular base station or access point 12, 16 to operate within communication system 10.

Typically, base stations are used for cellular telephone systems and like-type systems, while access points are used for in-home or in-building wireless networks. Regardless of the particular type of communication system, each wireless communication device includes a built-in radio and/or is coupled to a radio. The radio includes a highly linear amplifier and/or programmable multi-stage amplifiers to enhance performance, reduce costs, reduce size, and/or enhance broadband applications.

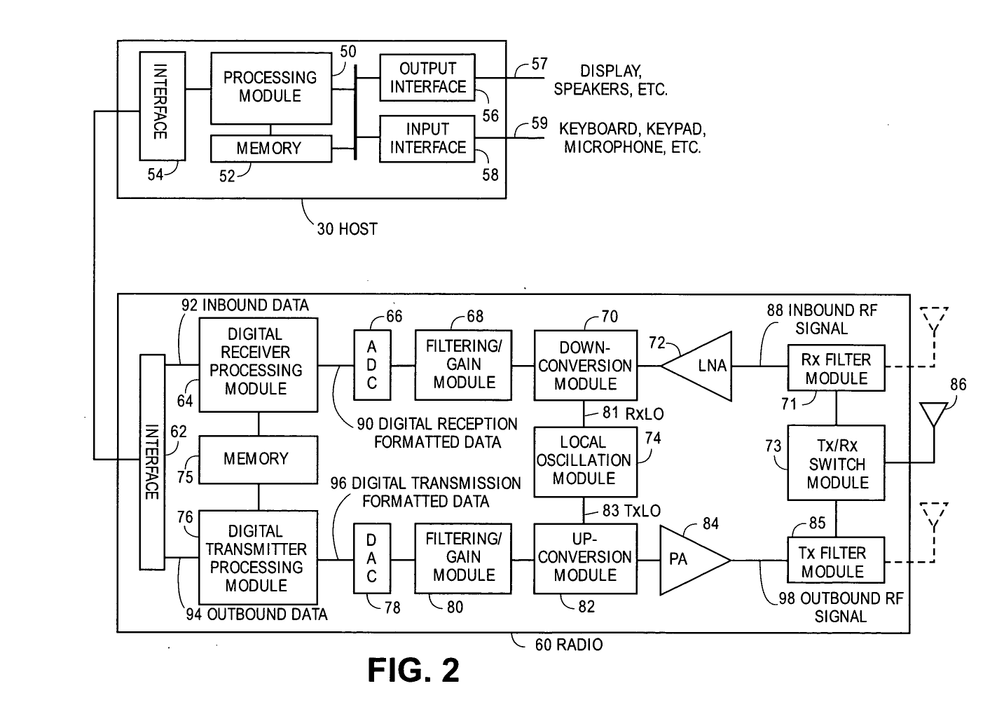

FIG. 2 is a schematic block diagram illustrating a wireless communication device that includes a host unit 30 and an associated radio unit 60. Host unit 30 may be incorporated in a communication device, such as one or more of the wireless communication devices shown in FIG. 1. For cellular telephone hosts, radio 60 is typically a built-in component. For personal digital assistants hosts, laptop hosts, and/or personal computer hosts, radio 60 may be built-in or may be an externally coupled component that couples to host device 30 via a communication link, such as a PCI interface, PCMCIA interface, USB interface, or another type of interface.

As illustrated, host device 30 includes a processing module 50, memory 52, radio interface 54, input interface 58, and output interface 56. Processing module 50 and memory 52 execute corresponding instructions that are typically done by the host device. For example, for a cellular telephone host device, processing module 50 performs the corresponding communication functions in accordance with a particular cellular telephone standard.

Radio interface 54 allows data to be received from and sent to radio 60. For inbound data received from radio 60, radio interface 54 provides the data to processing module 50 for further processing and/or routing to output interface 56. Output interface 56 provides connectivity to an output display device 57, such as a display, monitor, speakers, et cetera, such that the received data may be displayed or otherwise output. Radio interface 54 also provides outbound data from processing module 50 to radio 60. Processing module 50 may receive the outbound data from an input device 59, such as a keyboard, keypad, microphone, et cetera, via input interface 58 or generate the data itself. For data received via input interface 58, processing module 50 may perform a corresponding host function on the data and/or route it to radio 60 via radio interface 54.

Radio 60 includes a host interface 62, a digital receiver processing module 64, an analog-to-digital converter (ADC) 66, a filtering/gain/attenuation module 68, an intermediate frequency (IF) mixing down conversion stage noted as down-conversion module 70, a receiver filter module 71, a low noise amplifier (LNA) 72, a transmitter/receiver (Tx/Rx) switch module 73, a local oscillation module 74, a memory 75, a digital transmitter processing module 76, a digital-to-analog converter (DAC) 78, a filtering/gain/attenuation module 80, an IF mixing up conversion stage noted as up-conversion module 82, a power amplifier (PA) 84, a transmitter filter module 85, and an antenna 86. The antenna 86 may be a single antenna that is shared by the transmit and receive paths as controlled by Tx/Rx switch 73, or may include separate antennae for the transmit path and receive path (shown by the dotted line). The antenna implementation may depend on the particular standard to which the wireless communication device is compliant.

Digital receiver processing module 64 and digital transmitter processing module 76, in combination with operational instructions stored in memory 75, execute digital receiver functions and digital transmitter functions, respectively. The digital receiver functions include, but are not limited to, digital intermediate frequency to baseband conversion, demodulation, constellation demapping, decoding, and/or descrambling. The digital transmitter functions include, but are not limited to, scrambling, encoding, constellation mapping, modulation, and/or digital baseband to IF conversion. Digital receiver and transmitter processing modules 64 and 76 may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when processing module 64 and/or 76 implements one or more of its functions via a state machine, analog circuitry, digital circuitry, and/or logic circuitry, the memory storing the corresponding operational instructions may be embedded with the circuitry comprising the state machine, analog circuitry, digital circuitry, and/or logic circuitry. Memory 75 stores, and the processing module 64 and/or 76 executes, operational instructions that facilitate functionality of the device. In some embodiments, the combination of digital receiver processing module 64, digital transmitter processing module 76 and memory 75 may be referred to together as a “baseband processor.”

In operation, radio 60 receives outbound data 94 from host 30 via host interface 62. Host interface 62 routes outbound data 94 to digital transmitter processing module 76, which processes outbound data 94 in accordance with a particular wireless communication standard (e.g., IEEE802.11a, IEEE802.11b, IEEE802.11g, Bluetooth, et cetera) to produce digital transmission formatted data 96. Digital transmission formatted data 96 is typically a digital base-band signal or a digital low IF signal, where the low IF typically may be in the frequency range of one hundred kilohertz to a few megahertz (MHz).

Digital-to-analog converter 78 converts digital transmission formatted data 96 from the digital domain to the analog domain. Filtering/gain/attenuation module 80 filters and/or adjusts the gain of the analog signal prior to providing it to up-conversion module 82 for mixing. Up-conversion module 82 directly converts the analog baseband or low IF signal into an RF signal based on a transmitter local oscillation (Tx LO) 83 provided by local oscillation module 74. Power amplifier 84 amplifies the RF signal to produce outbound RF signal 98, which is filtered by transmitter filter module 85. Antenna 86 propagates outbound RF signal 98 to a targeted device such as a base station, an access point and/or another wireless communication device.

Radio 60 also receives inbound RF signal 88 via antenna 86, which was transmitted by a base station, an access point, or another wireless communication device. Antenna 86 provides inbound RF signal 88 to receiver filter module 71 via Tx/Rx switch 73, where Rx filter 71 bandpass filters inbound RF signal 88. Rx filter 71 provides the filtered RF signal to low noise amplifier 72, which amplifies signal 88 to produce an amplified inbound RF signal. The low noise amplifier 72 provides the amplified inbound RF signal to down-conversion module 70, which directly converts the amplified inbound RF signal into an inbound low IF signal or baseband signal based on a receiver local oscillation (Rx LO) 81 provided by local oscillation module 74. Down-conversion module 70 provides the inbound low IF signal or baseband signal to filtering/gain/attenuation module 68. Filtering/gain/attenuation module 68 may be implemented to filter and/or attenuate the inbound low IF signal or the inbound baseband signal to produce a filtered inbound signal.

Analog-to-digital converter 66 converts the filtered inbound signal from the analog domain to the digital domain to produce digital reception formatted data 90. Digital receiver processing module 64 decodes, descrambles, demaps, and/or demodulates digital reception formatted data 90 to recapture inbound data 92 in accordance with the particular wireless communication standard being implemented by radio 60. Host interface 62 provides the recaptured inbound data 92 to host device 30 via radio interface 54.

As one of ordinary skill in the art will appreciate, the particular wireless communication device of FIG. 2 may be implemented using one or more integrated circuits. For example, host 30 may be implemented on one integrated circuit and digital receiver processing module 64, digital transmitter processing module 76 and memory 75 may be implemented on a second integrated circuit, and the remaining components of radio 60, less the antenna 86, may be implemented on a third integrated circuit. As an alternative embodiment, radio 60 may be implemented on a single integrated circuit. As yet another alternative embodiment, processing module 50 of host 30 and digital receiver and transmitter processing modules 64 and 76 may be a common processing device implemented on a single integrated circuit. Further, memory 52 and memory 75 may be implemented on a single integrated circuit and/or on the same integrated circuit as the common processing modules of processing module 50 and digital receiver and transmitter processing module 64 and 76. Generally, radio 60 is defined as having a baseband portion and a RF portion.

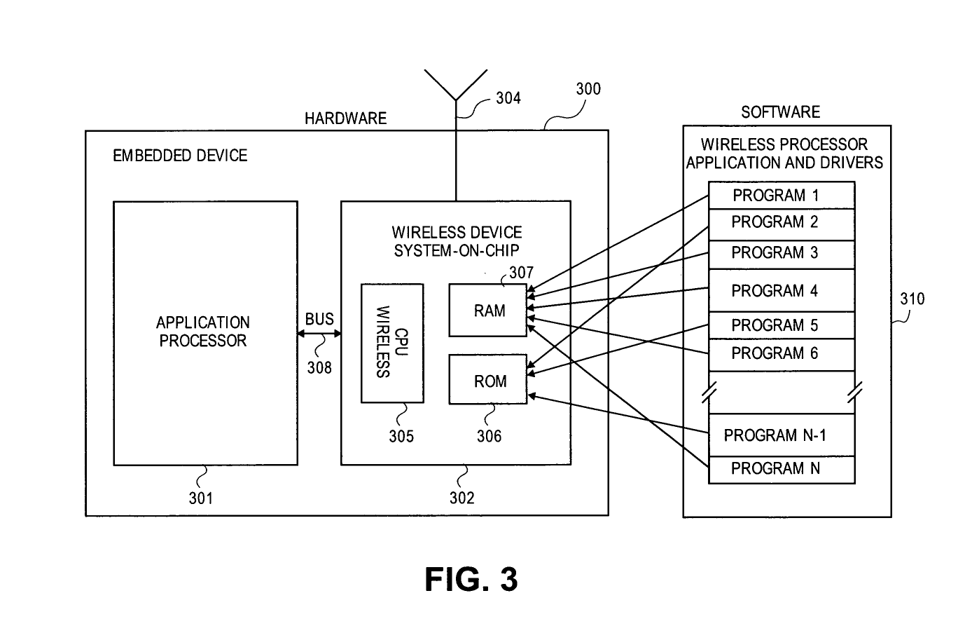

FIG. 3 shows an application of a hardware device, such as one of the wireless devices of FIG. 1. Hardware device 300 in one embodiment is a small portable unit, such as a cell phone or a down-loadable music player. However, device 300 need not be limited only to cell phones and music players. Other embodiments may incorporate other hardware. The hardware portion is shown in the large block at the left of FIG. 3 and in one embodiment, the hardware is an embedded device. Hardware device 300 includes an application processor device portion 301 and a wireless device portion 302. In the particular embodiment, wireless portion 302 is a system-on-chip (SoC), in which the wireless portion 302 is constructed on one integrated circuit (IC) chip to operate as a SoC. In other embodiments, wireless portion 302 may be separated into two or more ICs. A bus 308 couples the two portions 301, 302.

It is to be noted that in one embodiment, application processor device portion 301 may comprise host 50 of FIG. 2 and wireless device portion 302 may comprise radio 60 of FIG. 2, with bus 308 coupling the radio to the host. Bus 308 may be one of a variety of buses or connections used for coupling the two portions 301, 302. For example, bus 308 may be a Universal Serial Bus (USB) or a Secure Digital Input/Output (SDIO) connection in some embodiments.

Wireless device 302 includes a wireless processor, shown as Central Processing Unit (CPU) 305, or some other equivalent processor, read-only memory (ROM) 306 and random-access memory (RAM) 307. CPU 305 performs processing of various wireless functions and in one embodiment, may provide the various conversion functions noted in radio 60 FIG. 2. In another embodiment, CPU 305 operates as a co-processor to the main application processor to handle the wireless processing. The ROM 306 and RAM 307 provide the various storing functions as noted below. It is generally understood that ROM is a non-volatile memory which is read only and RAM is a volatile memory that has both read and write capability. Furthermore, although ROM and RAM are specifically identified, other memory devices that operate equivalently to ROM and/or RAM may be implemented instead. Thus, a variety of read-write memory may be used in place of RAM 307. Also, in reference to FIG. 2, memory 75 may comprise both ROM 306 and RAM 307.

As noted in the Background section above, boot programs are generally stored in ROM, but that other programs, such as applications programs, are stored in RAM. This allows application programs to be loaded as needed. Loading applications programs in RAM also allows such programs to be updated or replaced. Although ROMs utilize much less real estate on a chip and consume much less power than a comparable bit storage RAM, applications are not loaded in ROM, since such ROM loaded applications are read-only after initial loading in the ROM.

As is described below, in the practice of the invention ROM 306 not only stores the boot programming, it also stores portions of programming generally destined for storage in RAM 307. A large block portion at the right of FIG. 3 denotes software 310 that would normally be stored in RAM under typical loading of such programs in RAM. For example, in one embodiment software 310 is comprised of wireless application programs and/or driver programs. A typical prior art practice is to load all of the application and/or driver programs into RAM. However, if the various programs, noted as Programs 1 through Program N, that comprise software 310 are loaded into RAM, a RAM of some sufficient size is required. However, if some or portions of software 310 are loaded into ROM 306, then less storage space is required in RAM 307. Since equivalent bit storage for ROM is less in terms of real estate on a chip, as well as power consumption, a substantial advantage is gained.

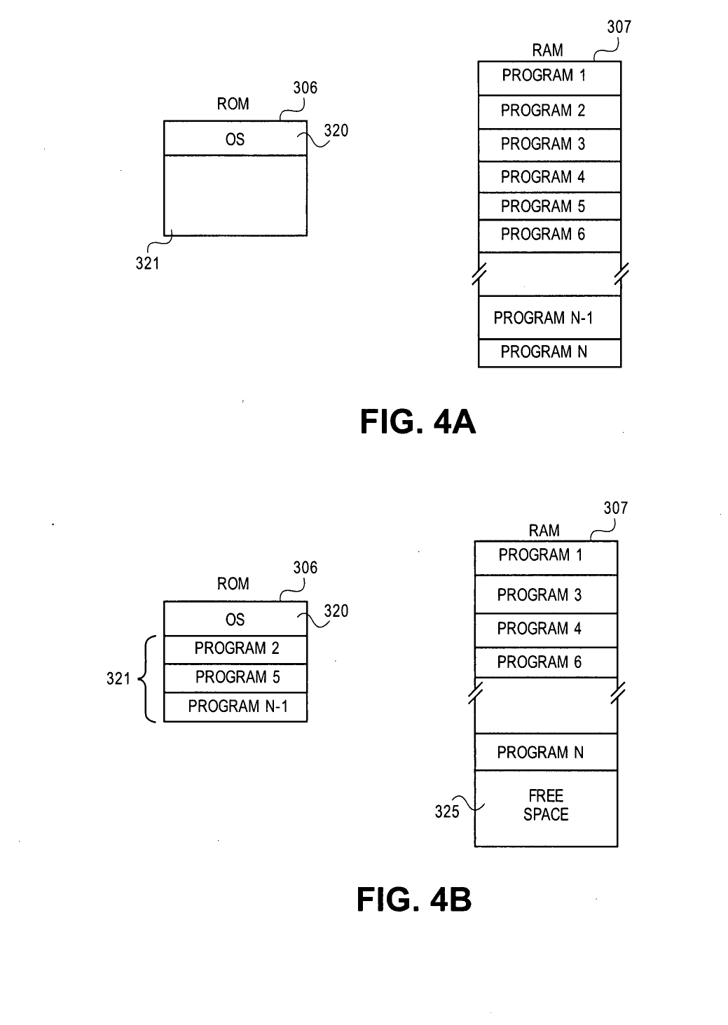

Accordingly, as shown in FIG. 3, some programs are loaded into ROM 306 while the remaining programs are loaded into RAM 307. In the particular example of FIG. 3, Program 2, Program 5 and Program N−1 are loaded into ROM 306 while the remaining programs are loaded into RAM 307. Using the example of loading Programs 2, 5 and N−1 into ROM 306, FIG. 4A shows a situation if these programs were not loaded into ROM 306, but rather into RAM 307. ROM 306 would typically contain a boot program, shown as operating system (OS) 320 in FIG. 4A. A portion 321 of ROM 306 is shown as free space. The loading of only OS 320 in ROM 306, while the application and driver programs are loaded into RAM 307, is the typical prior art situation with the usage of ROM and RAM devices.

FIG. 4B illustrates a situation when some portions of the software that are typically destined for RAM 307 are actually placed in ROM 306. With the above noted example, ROM 306 now contains OS 320, along with Programs 2, 5 and N−1 in portion 321. RAM 307 now requires less storage space, as noted by free space 325 created by vacating Programs 2, 5 and N−1 from RAM 307.

As noted in FIGS. 4A and 4B, the amount of storage space required is substantially the same, whether the Programs 1 through N are stored all in RAM 307 or separated between ROM 306 and RAM 307. However, storing some of the programs in ROM 306 allows less RAM 307 storage. Considering that RAM bit storage cells are generally larger and consumes more power than ROM bit storage cells, significant real estate on a given SoC may be saved by using the scheme of FIG. 4B. Likewise, significant power savings may be obtained as well with the scheme of FIG. 4B. For example, in one particular embodiment, ROM memory cells are approximately ¼ to ⅕ the size of RAM memory cells. A 128K of RAM takes approximately 1 mm² of chip real estate, while 128K of ROM takes 0.25 mm² of chip real estate. For equivalent 128K of memory, less power is consumed by the ROM.

Accordingly, by placing certain programs in ROM 306, instead of RAM 307, advantages may be derived in chip real estate savings and power consumption, which also reduce costs. However, the downside is that programs loaded into ROM 306 are fixed and may not be changed easily as compared to loading them in RAM 307. Therefore, in order to practice the invention, one of the criteria is to determine programs or set of code that are not anticipated to change over a time period and/or a number of future revision cycles of the software. It is to be noted that the description herein refers to programs, but programs are used as a reference term only. The software stored in ROM may be complete programs, portions of a program, routines, subroutines or other code. It need not be limited to complete programs. Thus, software code that is determined to not change over a time period may be stored in ROM 306. For example, code that may be part of (or work in conjunction with) another program that is determined to not change over a number of revision cycles of the main program, may be stored in ROM 306.

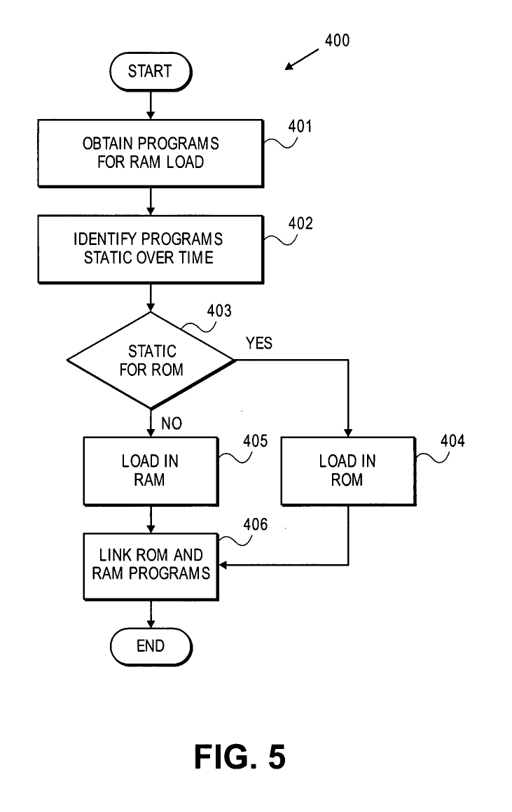

FIG. 5 illustrates one example technique for loading some of the software in ROM 306 and the rest in RAM 307. Programs that are typically destined for RAM loading are obtained (block 401) and those portions that remain static (unchanged) over time or revision cycles are identified (block 402). When loading the programs in the device, the programs identified as static over time (block 403) are loaded into ROM (block 404) and the remainder in RAM (block 405). Then the RAM and ROM programs are linked (block 406), so that program execution may transition from RAM to ROM and vice versa.

Since it is possible that a portion or portions of one program may reside in ROM, while the remaining portions of a program reside in RAM, some form of linkage may be required. A variety of techniques, including known techniques for linking storage addresses, may be used. For example, in one embodiment, a program pointer may be used to link from a RAM location to a ROM location, with a return pointer back to the RAM. In another technique, a look-up table may be set up in the ROM to identify the various storage locations for the code stored in ROM. The RAM then accesses the look-up table in ROM to find the code that is being called. In another technique, the look-up table may be set up in RAM. Various other techniques may be readily made operable to link the programs stored in RAM to programs stored in ROM.

Furthermore, in some instances, there may be scenarios in which one or more portions of code stored in ROM require updating. It was intentioned that this code would not change over time, but circumstances may dictate that a change to this code is warranted. In that instance, the new code to replace or update the portion of ROM code may now be placed back into RAM. Pointers or links in RAM that had linked to ROM may now be revised to link to the new update in RAM and the previous code in ROM may be ignored. Many other scenarios may be readily adapted to take advantage of storing software in ROM and RAM.

As a further example of the practice of the invention, in one embodiment a cell phone uses a smaller RAM, simply by storing certain code in ROM. At a time when OS code is burned into the ROM of the cell phone, certain application/driver code that is destined for storage in RAM is loaded into the ROM instead, because this portion of the code is determined not to change over time. The ROM loaded portion may be a complete program or a portion of another program. For example, in one embodiment, CPU 305 operates as an accelerator to application processor 301. In this mode of operation, portions of a device driver for the wireless device 302, as well as portions of an application routine for forwarding packets using one of the 802.11 communication protocol are stored in ROM 306. It is to be noted that various other scenarios are possible in other embodiments for practicing the invention.

Thus, a technique to partially store software functions in ROM instead of RAM is described.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items.

Furthermore, the term “module” is used herein to describe a functional block and may represent hardware, software, firmware, etc., without limitation to its structure. A “module” may be a circuit, integrated circuit chip or chips, assembly or other component configurations. Accordingly, a “processing module” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions and such processing device may have accompanying memory. A “module” may also be software or software operating in conjunction with hardware.

The embodiments of the present invention have been described above with the aid of functional building blocks illustrating the performance of certain functions. The boundaries of these functional building blocks have been arbitrarily defined for convenience of description. Alternate boundaries could be defined as long as the certain functions are appropriately performed. Similarly, flow diagram blocks and methods of practicing the embodiments of the invention may also have been arbitrarily defined herein to illustrate certain significant functionality. To the extent used, the flow diagram block boundaries and methods could have been defined otherwise and still perform the certain significant functionality. Such alternate definitions of functional building blocks, flow diagram blocks and methods are thus within the scope and spirit of the claimed embodiments of the invention. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

We claim:

1. An apparatus comprising:
a read-write memory to store software for use with a wireless device; and
a read-only memory (ROM) to store portions of the software that have been determined to not change over time in order to reduce a size of the read-write memory.

2. The apparatus of claim 1, wherein the software is an application program to operate a function of the wireless device.

3. The apparatus of claim 1, wherein the software is a driver program to operate a driving function of the wireless device.

4. The apparatus of claim 1, wherein the read-write memory is a random-access memory (RAM).

5. An apparatus comprising:
a wireless processor to provide radio processing to operate a wireless device;
a read-write memory to store software for use with the wireless processor; and
a read-only memory (ROM) to store portions of the software that have been determined to not change over time in order to reduce a size of the read-write memory.

6. The apparatus of claim 5, wherein the read-write memory is a random-access memory (RAM).

7. The apparatus of claim 6, wherein the wireless processor, ROM and RAM are constructed on a single integrated circuit chip as a system-on-chip.

8. The apparatus of claim 7, further including an application processor coupled to the wireless processor to provide application processing for the wireless device.

9. The apparatus of claim 8, wherein the application processor provides cell phone application for the wireless device.

10. The apparatus of claim 8, wherein the application processor provides down-loadable music application for the wireless device.

11. A method comprising:
obtaining software to operate with a wireless device for loading into a read-write memory of the wireless device;
identifying portions of the software that does not change over time;
loading the portions of the software that does not change over time into a read-only memory (ROM); and
loading remaining portions of the software in a read-write memory, in which storing the portions of the software that have been identified to not change over time in the ROM allows less read-write memory to operate the software with the wireless device.

12. The method of claim 1, wherein loading remaining portions of the software in the read-write memory includes loading the remaining portions of the software into a random-access memory (RAM).

13. The method of claim 12, wherein identifying a portion of the software that does not change over time includes identifying software that does not change over future revisions of the software.

14. The method of claim 12, further including linking the portions of the software stored in the ROM to remaining portions stored in the RAM.

15. The method of claim 14, wherein linking the software includes using a look-up table in either the ROM or the RAM.
